(19) United States
(12) Patent Application Publication
(10) Pub. No.: US 2014/0337160 A1
(43) Pub. Date: Nov. 13, 2014

(54) CONSIDERING SOCIAL INFORMATION IN GENERATING RECOMMENDATIONS

(71) Applicant: MICROSOFT CORPORATION, Redmond, WA (US)

(72) Inventors: Woo Hyun Jin, Bellevue, WA (US); Siddharth Uppal, Bothell, WA (US)

(73) Assignee: Microsoft Corporation, Redmond, WA (US)

(21) Appl. No.: 13/890,246

(22) Filed: May 9, 2013

(51) Int. Cl. G06Q 30/06; G06Q 50/00

(52) U.S. Cl. CPC G06Q 30/0631; G06Q 50/01
USPC 705/26.7

(57) ABSTRACT

Transaction data is obtained from sellers. The data identifies individuals and products or items that they have purchased from the sellers. Social network data is also obtained. It identifies a social graph for a plurality of different users. A mapping between the social graphs and the transaction data is generated to identify which items have been purchased by which individuals in the social graph of a given user.

### BACKGROUND

Computer systems are currently in wide use. They are used for many different purposes.

In one example, computer systems are used to enable users to purchase things. For example, retail establishments often have computer systems that provide a retail website. The website has product browsing and purchasing capabilities. This allows a user to navigate to the website and browse products available from the retailer, and also to purchase products. Similarly, such websites often include search capabilities which allow the user to search for various different products, using, for instance, keyword searching. The search functionality often searches the products or services offered by the retailer and returns a set of search results based on the keywords input by the user.

Computer systems are also widely used in implementing social media services. Users can create social network sites (or accounts) that are connected to social network sites (or accounts) of others through a social media service. The social network connections between a given user and other users of the social media are sometimes referred to as the given user's social graph. The graph can include not only connections to other users of the social media service, but it can also include connections to a given subject matter area, various products, or groups, etc.

In making a purchasing decision, it is believed that recommendations from a friend are more valuable to a purchaser than recommendations from a stranger. It is even believed that recommendations by a purchaser's friend, on a social network, are more valuable than recommendations by strangers. In fact, it is believed by some that individuals who actively interact on social network sites are likely to be quite socially influential of one another in making purchasing decisions.

The discussion above is merely provided for general background information and is not intended to be used as an aid in determining the scope of the claimed subject matter.

### SUMMARY

Transaction data is obtained from sellers. The data identifies individuals and products or items that they have purchased from the sellers. Social network data is also obtained. It identifies a social graph for a plurality of different users. A mapping between the social graphs and the transaction data is generated to identify which items have been purchased by which individuals in the social graph of a given user.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one illustrative architecture in which a social retail system can be deployed.

FIG. 2 is a flow diagram illustrating one embodiment of the overall operation of the social retail system shown in FIG. 1 in generating mappings between transaction data and individuals identified in social network data.

FIG. 2A is one illustrative user interface display.

FIGS. 3A and 3B show a flow diagram illustrating one embodiment of the operation of a device in displaying recommendations from a seller's webpage based on the mappings.

FIGS. 4A-4D show illustrative user interface displays.

FIG. 5 is a flow diagram of one illustrative embodiment of the operation of the social retail system shown in FIG. 1 in generating recommendations.

FIG. 6 is a block diagram showing the social retail system of FIG. 1 in various architectures.

FIGS. 7-12 show embodiments of mobile devices.

FIG. 13 is a block diagram showing one embodiment of a computing environment.

### DETAILED DESCRIPTION

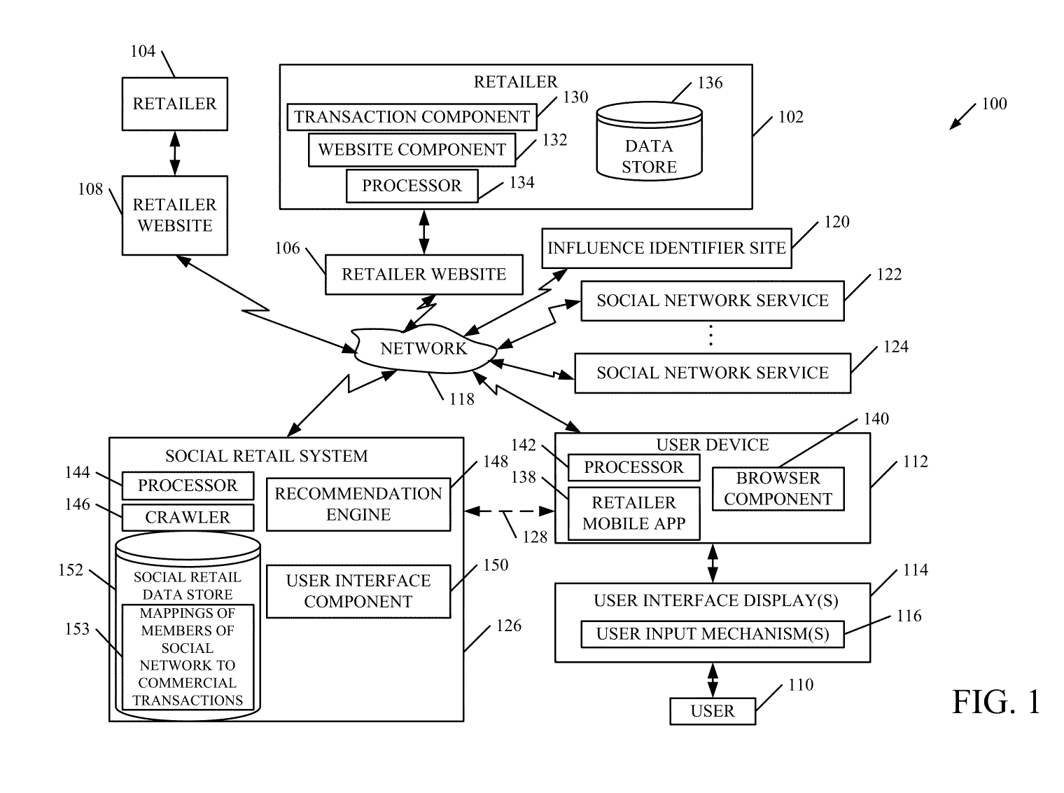

FIG. 1 is a block diagram of one illustrative architecture 100 that shows a plurality of retailers 102 and 104, both of which maintain a retailer website 106 and 108, respectively. The retailers 102 and 104 are accessible by a user 110, using a user device 112 that generates user interface displays 114 with user input mechanisms 116 that can be used for interaction by user 110. User device 112 has access to retailers 102 and 104 over network 118. FIG. 1 also shows that influence identifier site 120 and social network sites 122 and 124 are accessible over network 118. In addition, architecture 100 includes social retail system 126 that can also be accessed by retailers 102 and 104, and can access sites 120, 122 and 124 over network 118. Also, in one embodiment, user device 112 can access social retail system 126 either over network 118, (such as through a retailer website or otherwise) or directly, as indicated by dashed arrow 128.

In the embodiment shown in FIG. 1, each retailer 102-104 illustratively includes a transaction component 130, website component 132, processor 134 and data store 136. They are only shown in retailer 102 for the sake of simplicity. Transaction component 130 illustratively includes functionality that allows a user to perform a commercial transaction (such as purchase a product or service from the retailer 102) through retailer website 106. Transaction component 130 illustratively tracks and maintains transaction data that reflects the transaction, and stores it in data store 136.

Website component 132 illustratively provides functionality for maintaining website 106. This allows the user to perform various operations with respect to retailer 102, such as searching for products or services, browsing the website, performing transactions, etc.

Processor 134 is illustratively a computer processor with associated memory and timing circuitry (not separately shown). It is illustratively a functional part of retailer 102 and is activated by, and facilitates the functionality of, other components or items in retailer 102.

Data store 136 is shown as a single data store, and as part of retailer 102. However, it can also be remote from retailer 102, and accessible by retailer 102. In addition, instead of a single data store, multiple data stores can be used. They can all be local to retailer 102, they can all be remote from retailer 102, or some can be local while others are remote.

User device 112 illustratively includes a retailer mobile application 138 that provides functionality for accessing one or more of retailers 102-104 through their corresponding websites. User device 112 is also shown with browser component 140 that allows user 110 to browse various sites over network 118. In addition, user device 112 is shown with processor 142. Processor 142 is illustratively a computer processor with associated memory and timing circuitry (not separately shown). It is illustratively a functional part of user device 112 and is activated by, and facilitates the functionality of, other items on user device 112.

User input mechanisms 116 that reside on user interface displays 114 illustratively receive user inputs from user 110 to control and manipulate user device 112. User input mechanisms 116 can be a wide variety of different user input mechanisms, such as buttons, icons, links, textboxes, dropdown menus, checkboxes, etc. In addition, they can be actuated in a wide variety of different ways, such as by using a point and click device (e.g., a mouse or trackball), by using a hard or soft keyboard, a keypad, a thumb pad, various mechanical switches and buttons, a joystick, etc. Further, where user device 112 has speech recognition components, they can be activated using speech commands. In addition, where the display screen on which user interface displays 114 are displayed is a touch sensitive screen, they can be activated using touch gestures (such as with the user's finger, a stylus, etc.).

Social network services 122 and 124 illustratively provide services that allow users to access and use social network sites or accounts. Users can illustratively have friends and followers, they can follow other users, they can link themselves to (or be linked to) users, groups, subject matter content, various products or services or events, etc. The other users or items that a given user is connected to on a social network site are referred to as the given user's social graph.

Influence identifier site 120 illustratively identifies various individuals that have some form of influence. For instance, it may identify individuals that have authored papers (or other publications) in a given subject matter area, as having influence in that area. Similarly, it may track the number of visitors that navigate to, or otherwise visit, the website of an individual and consider that in determining whether the individual has influence. It may track the number of followers of an individual, the number of recommendations that an individual makes (and that are followed by other users), or a wide variety of other information to determine whether an individual has influence in a given subject matter area, or with respect to a set of users.

Social retail system 126 is shown with processor 144, crawler 146, recommendation engine 148, user interface component 150 and social retail data store 152 that stores mappings 153 between the social graphs of users and the transaction data from the retailers. Processor 144 is illustratively a computer processor with associated memory and timing circuitry (not separately shown). It is illustratively a functional part of system 126 and is activated by, and facilitates the functionality of, other components, engines, or other items in social retail system 126.

Interface component 150 can be used to generate user interface displays (such as displays 114) that a user can interact with. Of course, user interface component 150 can simply provide information for those user interface displays, and the actual displays can be generated by other components as well.

Crawler 146 illustratively functions to crawl various websites or services (such as the websites of the retailers 102, 104, social network services 122 and 124, influence identifier site 120, etc.) to obtain information that can be stored in social retail data store 152. This information can include, for example, commercial transaction data for a given retailer (such as the identity of a person who made a purchase, and the product information and date corresponding to the purchase, as well as any social network identifiers corresponding to that purchaser). Crawler 146 also illustratively crawls and stores the social graphs for various users of social network services 122 and 124. Further, it crawls and stores influence information on influence identifier site 120.

Recommendation engine 148 illustratively accesses the data stored in social retail data store 152 and generates mappings between the social graph obtained from social network services 122-124 and commercial transaction data from retailers 102 and 104. Thus, recommendation engine 148 generates a mapping indicating which individual users in various social graphs purchased which individual products or services or other items from which retailers. Thus, when a user 110 is searching for a given product on a retailer website (such as website 106), recommendation engine 148 can obtain information about others who have purchased similar products in the user's social graph. This information can be displayed to the user on the retailer website 106.

Before describing the overall operation of architecture 100 in more detail, an overview will first be provided. In one embodiment, user 110 illustratively accesses the website of a retailer 102 or 104. For the purposes of the present discussion, retailers 102 and 104 are actual retailers, however they could be wholesalers, or other sellers of products or services. For the sake of simplicity, however, they will simply be referred to as retailers. When user 110 accesses the website (e.g., of retailer 102), the retailer website 106 illustratively makes a call to social retail system 126 with the identity of user 110. Recommendation engine 148 then accesses social retail data store 152 and generates recommendations (if they were not pre-generated) of products or services of the given retailer 102 that can be displayed to this specific user 110, along with the retailer's normal website page. It will be noted that recommendations can be pre-calculated as well, in which case they are retrieved by recommendation engine 148, instead of generated on-the-fly. User 110 can then see which people in the social graph of user 110 have purchased products from this retailer, and what those products are.

User 110 can also provide a search input, if the user is searching for a specific product. In that embodiment, the retailer website 106 again calls social retail system 126, along with the search input (or search request) that was provided by user 110. Recommendation engine 148 then accesses social retail data store 152 and generates (or retrieves) a new set of more specific recommendations showing which users in the social graph of user 110 have purchased a similar product. This is then also displayed to the user on retailer website 106. At the same time, of course, website component 132 is illustratively searching data store 136 for product information related to the search input provided by user 110. These search results can illustratively be re-ranked based on whether (and which) users in the social graph of user 110 have purchased products in the search results. For instance, those purchased by individuals in the social graph of user 110 can be ranked higher in the displayed search results than products that have not been purchased by anyone in the social graph of user 110.

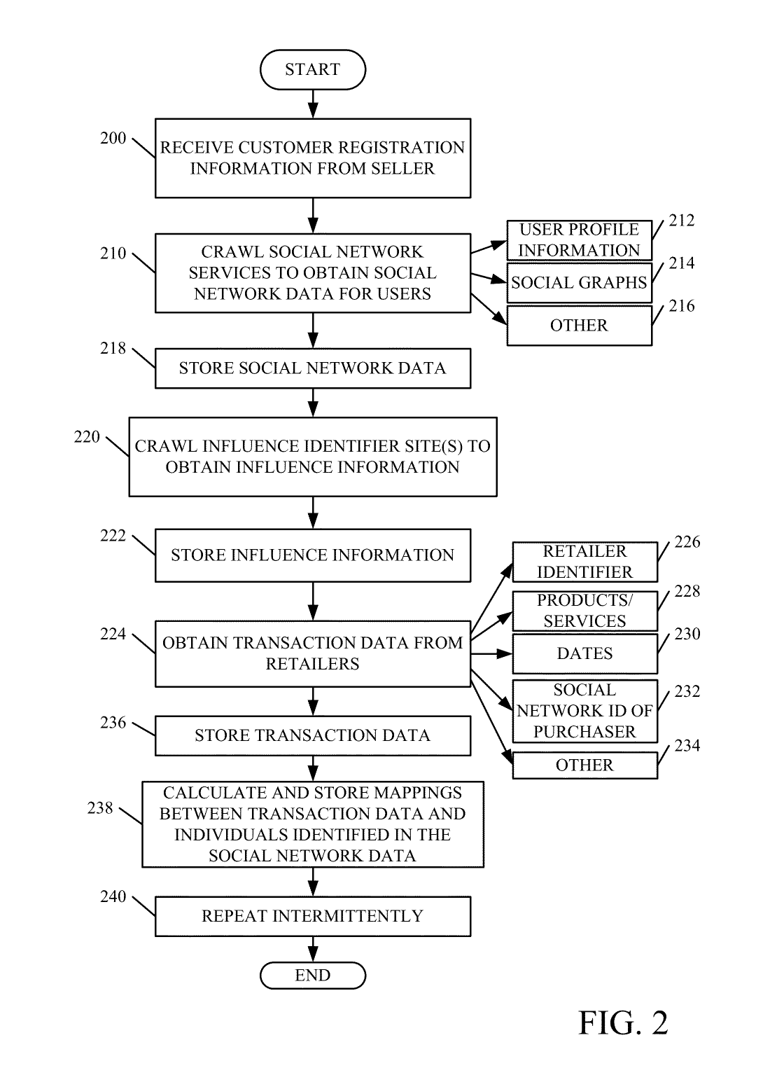

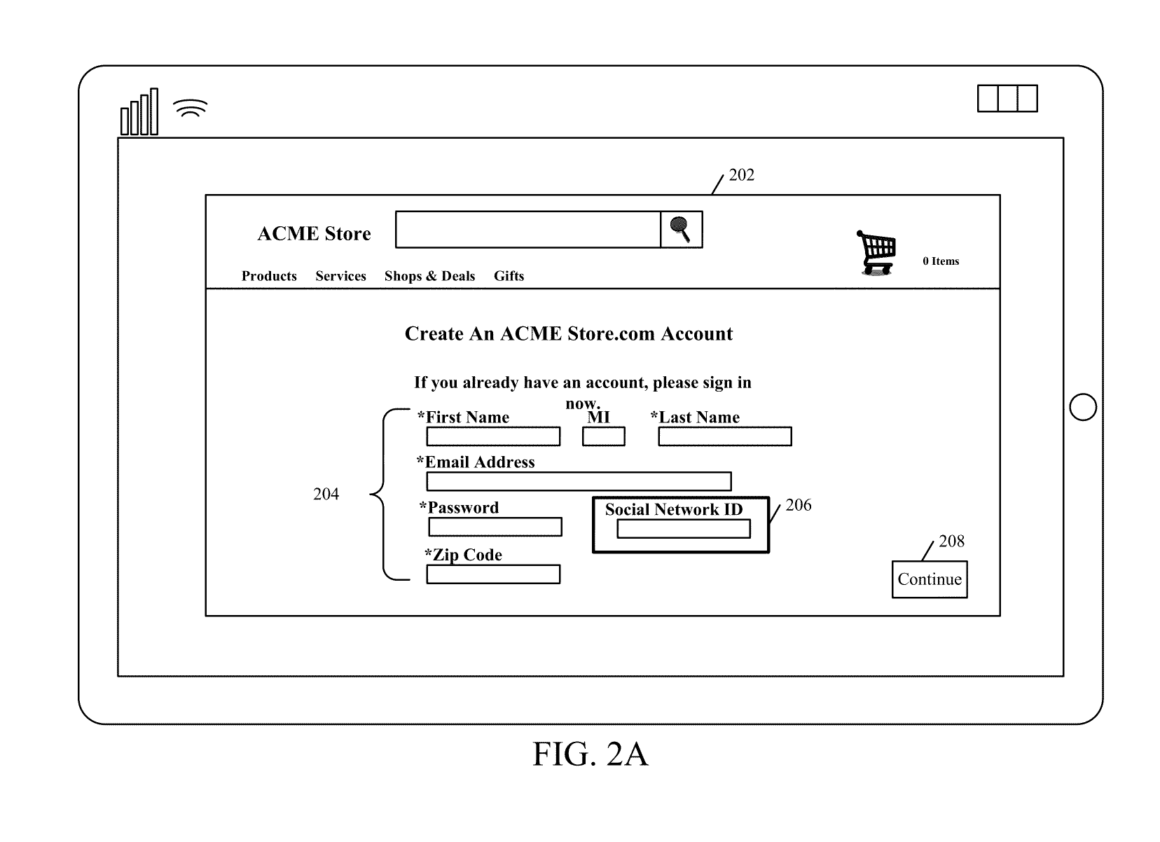

FIG. 2 is a flow diagram illustrating one embodiment of the operation of social retail system 126 in generating the mappings 153 between members of various social graphs and the transaction data representing the commercial transactions that they made at retailers 102-104. In doing so, website component 132 of retailer 102 (where the user is currently accessing website 106) illustratively generates a display screen that allows the user to register for a patronage program, a loyalty program, or another type of program, in order to obtain the social network information for the user. FIG. 2A shows one embodiment of a user interface display 202 that illustrates this. It can be seen in FIG. 2A that retailer 102 is “ACME Store”. The user interface display 202 allows the user to identify himself or herself using identification textboxes 204. In addition, the user illustratively provides one or more social network identifiers in box 206. When the user actuates the Continue button 208, this information is illustratively sent to social retail system 126 where it is stored in social retail data store 152. Receiving the registration information is indicated by block 200 in FIG. 2.

After receiving the social network identity of user 110, crawler 146 illustratively crawls the social network service or services 122-124 of which user 110 is a member. Crawler 146 retrieves social network data for user 110, and stores it in social retail data store 152. This is indicated by block 210 in FIG. 2. The social network data can illustratively include user profile information 212, all information that defines a social graph for user 110 on this particular social network, as indicated by block 214, and any other information 216 that may be helpful. Storing the social network data in data store 152 is indicated by block 218 in FIG. 2.

Crawler 146 also crawls influence identifier site 120 to obtain influence information that identifies individuals who have influence in certain social graphs or social networks, or with respect to certain subject matter areas, products, etc. Crawling the influence identifier site is indicated by block 220 in FIG. 2 and storing that information in data store 152 is indicated by block 222.

Social retail system 126 also obtains transaction data from retailers 102-104. This can be obtained in a wide variety of different ways. For instance, crawler 146 can crawl the retailer websites 106-108 which provide crawler 146 with access to this information. Alternatively, the database systems for retailers 102-104 can download the information to social retail system 126, or make it available for downloading by social retail system 126. Of course, there are a wide variety of other ways for social retail system 126 to obtain the transaction data as well. Obtaining the transaction data from the retailers is indicated by block 224.

This information can include a wide variety of different types of information. For instance, it can include a retailer identifier 226 that specifically identifies the retailer where the information was obtained. It can also include product and service information 228 that indicates the various products or services or other items that have been purchased from this retailer, along with the information identifying the users who purchased the product or services. It can include the date 230 on which the products or services were purchased and the social network identifier for all of the purchases corresponding to the transaction data, as indicated by block 232. Of course, the transaction data can include other information 234 as well. Storing the transaction data in social retail data store 152 is indicated by block 236 in FIG. 2.

Recommendation engine 148 then intermittently calculates and stores mappings between the transaction data and the individuals identified in the social network data. This is indicated by block 238. Recommendation engine 148 can calculate these mappings continuously, or intermittently, or even periodically at specified times of the day, the week, the month, etc., or calculation can be triggered by one or more events. Repeating the calculation intermittently is indicated by block 240 in FIG. 2.

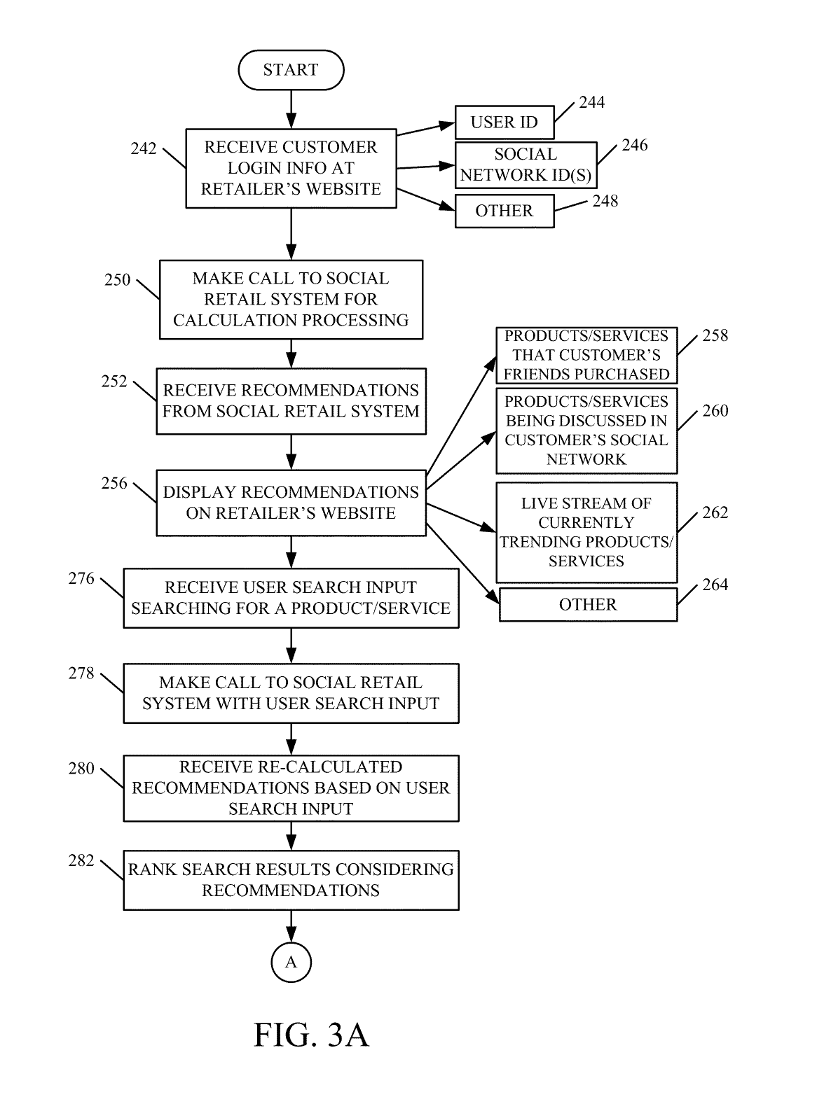

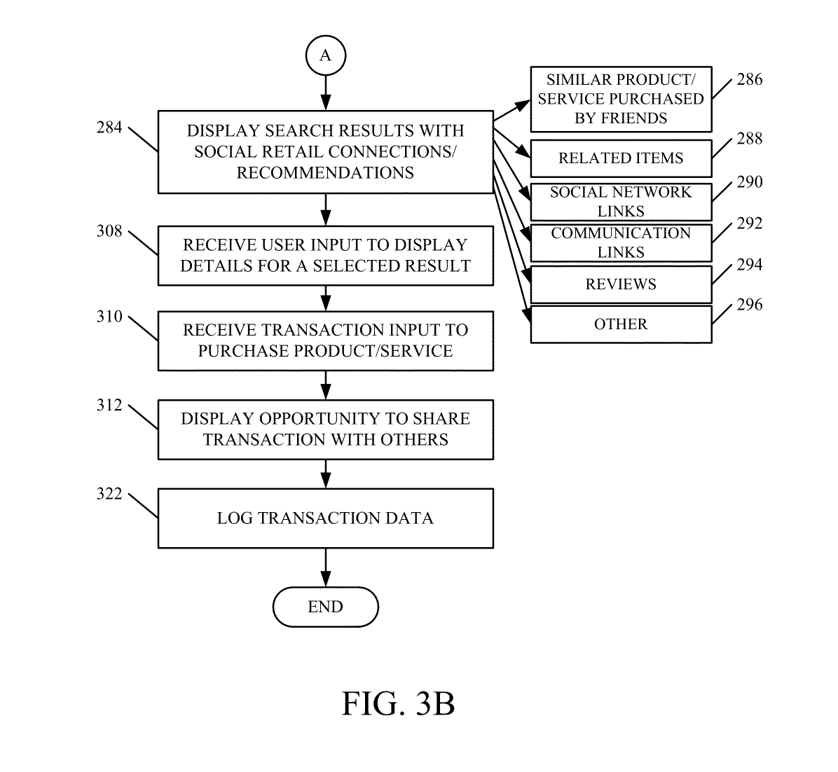

FIGS. 3A and 3B show a flow diagram illustrating one embodiment of the overall operation of architecture 100 in making recommendations to a user 110 who is accessing a retailer website 106 for a given retailer 102. First, user 110 accesses the retailer website 106. This can be done using a retailer mobile application 138, or by directly navigating to the retailer website 106, or in other ways. When the user has accessed website 106, the user is illustratively asked to provide customer login information. This is indicated by block 242 in FIG. 3A. The login information can include authentication information, the user's identifying information (such as name, address, etc.) as indicated by block 244. It also illustratively includes the user's social network identifiers 246 and can include a wide variety of other information 248 as well.

Retailer website 106 then illustratively calls social retail system 126 and provides the customer login information. This is indicated by block 250 in FIG. 2. Recommendation engine 148 then accesses data store 152 to identify other users in the social graph of user 110 that have purchased products from retailer 102 and provides those recommendations back to retailer website 106. This is indicated by block 252. Those recommendations are displayed on the retailer website 106 for viewing by the user. This is indicated by block 256.

The recommendations can include products or services that have been purchased by friends or others in the social graph of the current customer. This is indicated by block 258 in FIG. 3A. They can also include products or services being discussed in the social network of user 110. This is indicated by block 260. The recommendations can include a live stream of currently trending products or services for this given retailer. This is indicated by block 262. Of course, they can include other information 264 as well.

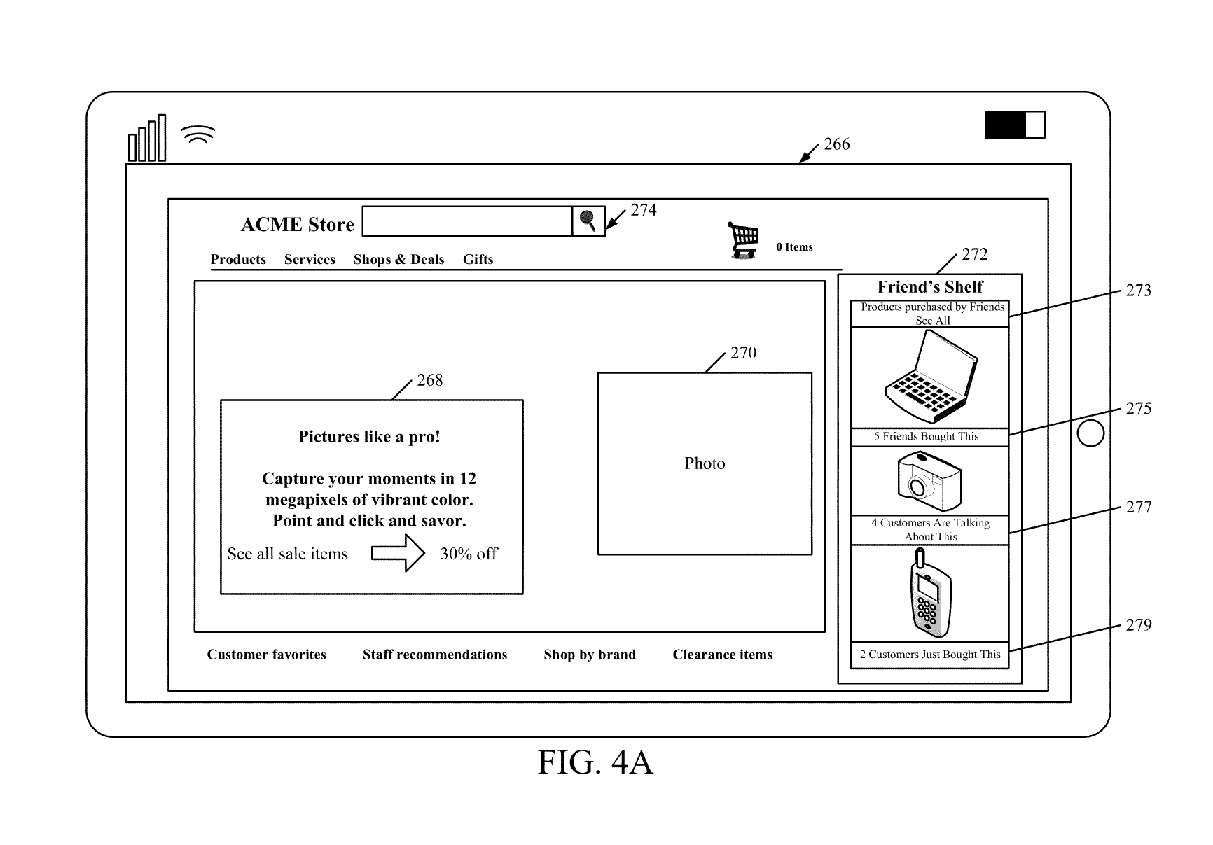

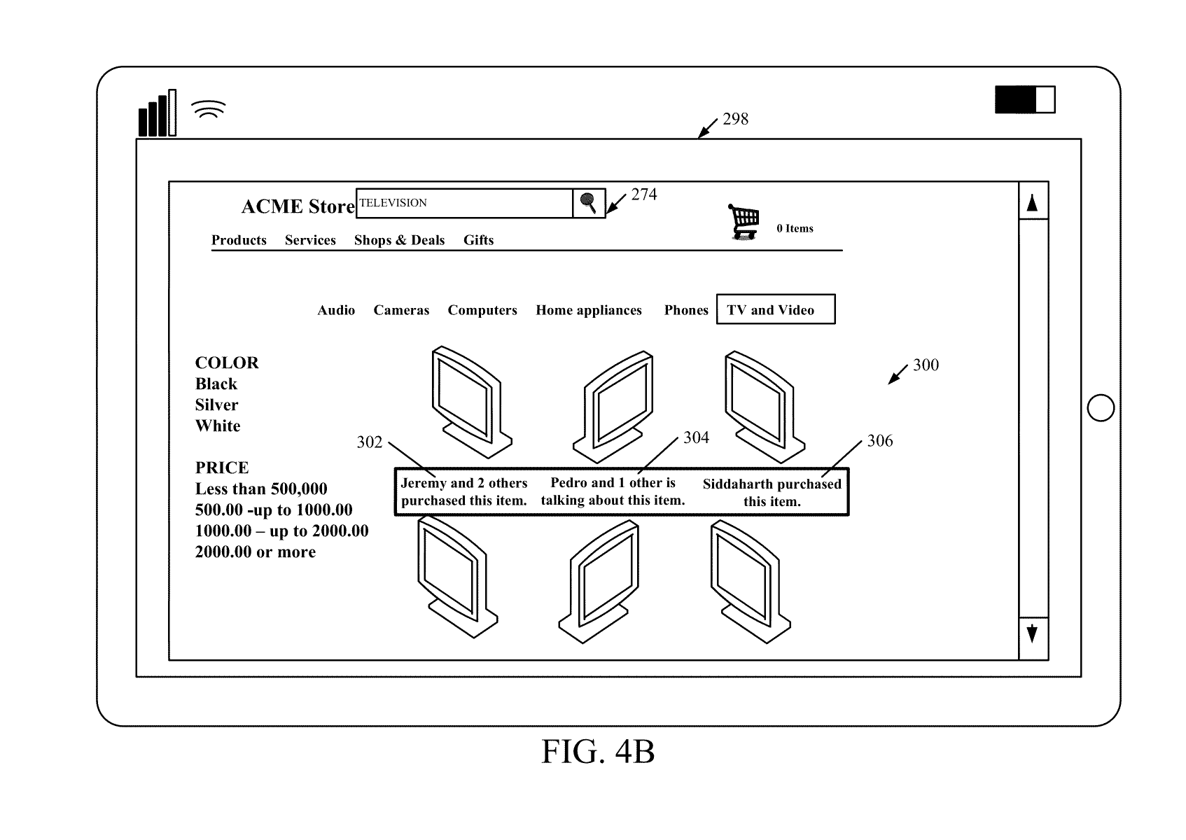

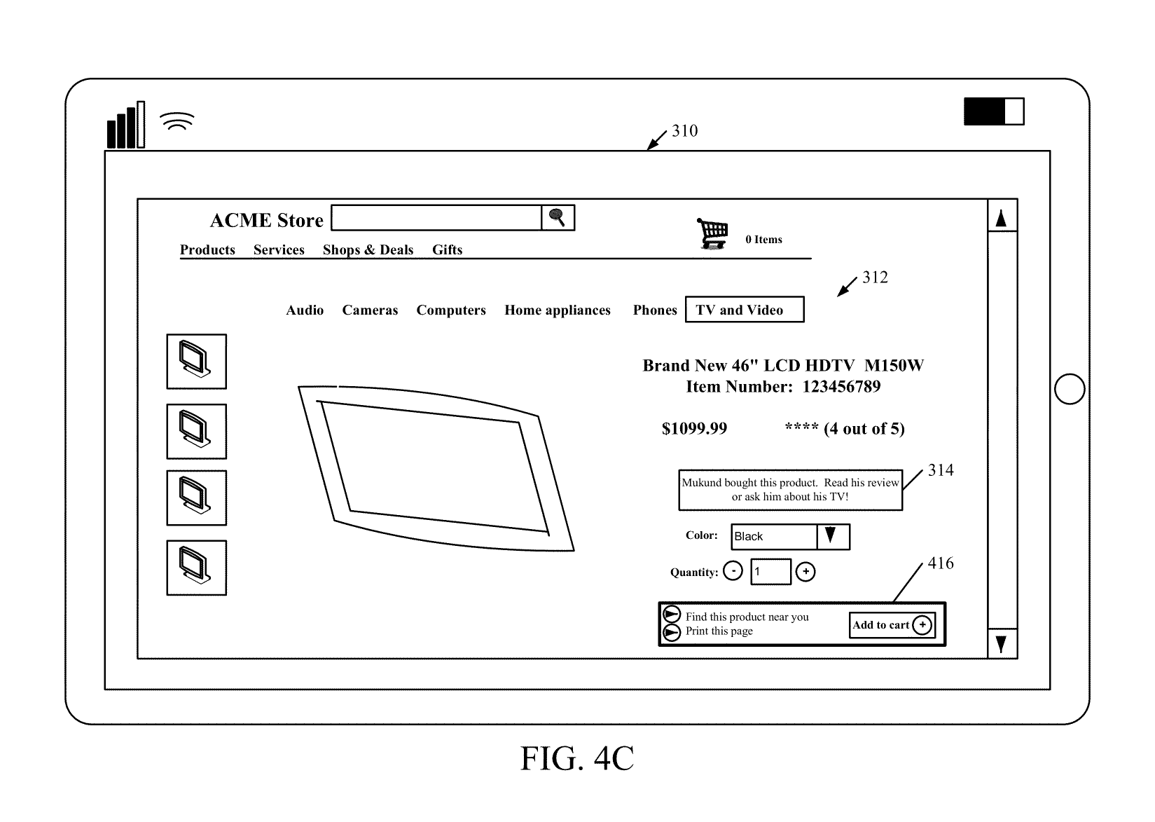

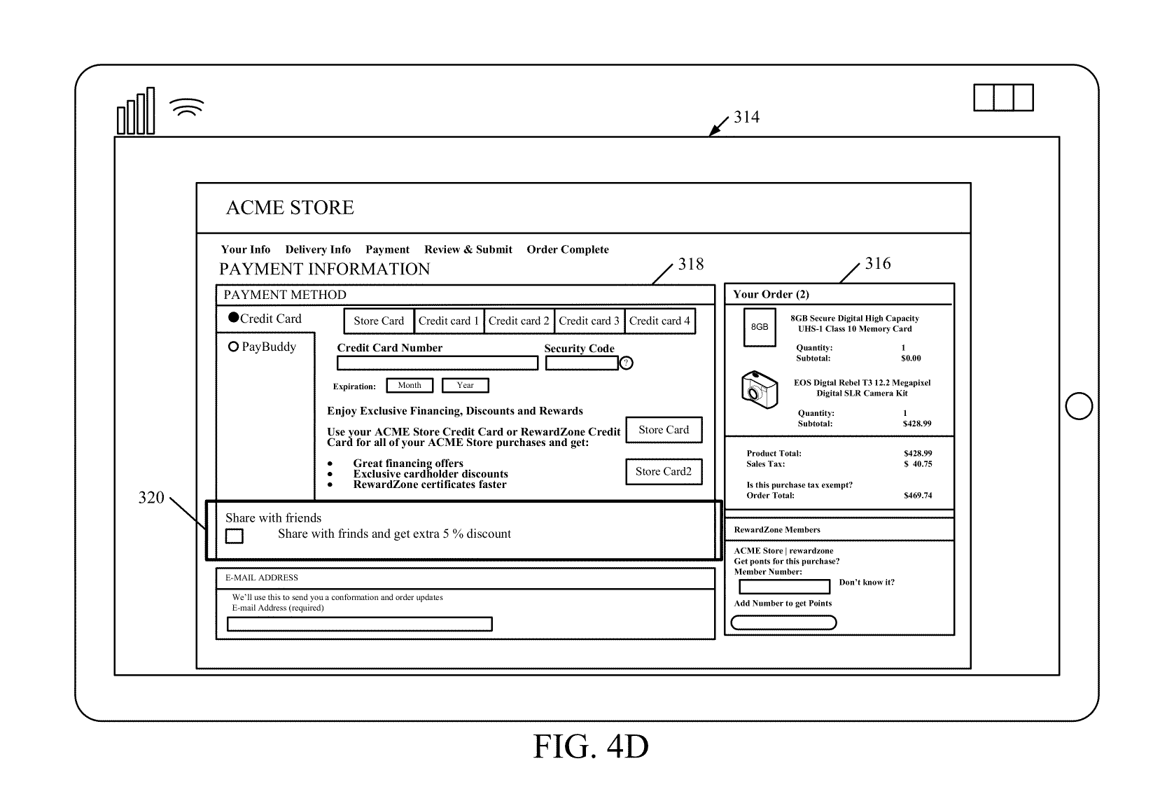

FIG. 4A shows one embodiment of a user interface display 266 that illustrates this. It can be seen that user interface display 266 is a welcome display for the “ACME store” and it includes an advertising portion 268, along with a photo or image 270 that can be associated with user 110 and displayed after user 110 provides his or her login information to the retailer website 106. In addition, display 266 includes a friend's shelf display (or recommendation display) 272 that shows products or services that have been purchased 275 by others in the social graph of user 110, products being discussed 277 by those in the social graph of user 110 and a line stream 279 of products currently being purchased. Display 272 also includes a display of all button 273 that allows the user 110 to see all products purchased from this retailer by others in his or her social graph. These correspond to the recommendations received from social retail system 126. They each illustratively include an actuatable link which, when actuated by user 110, navigates user 110 to a page that contains more details about that particular feature. Therefore, the user can simply review items on recommendation display 272, or the user can navigate to more detailed information or discussions about those products, etc. In addition, the user can provide a search input in search box 274 to look for a specific product or service offered by retailer 102. Receiving the user search input searching for a product or service is indicated by block 276 in FIG. 3A.

Upon receiving the search information in box 274, retailer website 106 illustratively provides the search information to website component 132 which includes a search engine for searching data store 136 for product information corresponding to the search input. In addition, retailer website 106 illustratively sends the search information to social retail system 126. Based on that information, recommendation engine 148 searches social retail data store 152 and generates (or retrieves) recommendations based on the search information and the mappings between transaction data for retailer 102 and individuals in the social graph of user 110. The recommendations illustratively include products for this retailer (that are similar to the product that the user 112 is searching for) that were purchased by people in the social graph of user 110. The recommendations also illustratively include the social graph data showing who, in the user's social graph, purchased the products. These recommendations are provided back to retailer website 106 where they can be used by website component 132.

For instance, website component 132 can simply display these recommendations to user 110. That is, it can display the products or services that match the search request and that were purchased by others in the user's social graph, along with an indication of who purchased the products or services. Also, it can re-rank the search results retrieved from data store 136 to rank products or services that match the search request inputs, and that were purchased by someone in the social graph of user 110, higher than other products or services that simply match the search request. The ranked search results are then displayed to the user on retailer website 106. Making the call to social retail system 126 with the search information (or search) is indicated by block 278. Receiving the recommendations based on the search request is indicated by block 280. Ranking the search results, considering those recommendations, is indicated by block 282, and displaying the search results, along with the social retail connection data (e.g., the identity of others who purchased the product or service) is indicated by block 284.

The search results, along with the social retail connections and recommendations can be displayed in a wide variety of different forms. For instance, the display can include similar products or services that were purchased by a friend (or another individual in the social graph of user 110). This is indicated by block 286. It can include a display of related items that were purchased by others as indicated by block 288. It can include social network links 290 which, when actuated by the user, navigate the user to the social network site of the other purchasers of the related items. It can include a communication link 292 that initiates a communication (such as an instant messaging session, an electronic mail message, a text (SMS) message, a telephone call, etc.) to the other users that have purchased similar items. It can include reviews written by other users in the social graph of user 110, as indicated by block 294, or it can include a wide variety of other information 296.

FIG. 4B shows one embodiment of a user interface display 298 that illustrates this. It can be seen that the user has typed “television” in search box 274. Website component 132 has illustratively retrieved search results shown generally at 300 based on the search input. The search results 300 include the identity 302, 304 and 306 of individuals in the social graph of user 110 that have purchased products found in the search results. Each displayed item 302, 304 and 306 is illustratively a link that can be actuated to navigate to other related information. For instance, link 302 can be actuated to navigate user 110 to the social network site of “Jeremy”, or to a review written by “Jeremy”, or to more detailed product information (provided by Jeremy) about the product purchased by “Jeremy”, etc. Also, each of the search results 300 that corresponds to a given product or service illustratively has a link that can be actuated by user 110 in order to navigate to more detailed product information (about that particular product), provided by retailer 102.

Receiving a user input to display more detailed information about a selected search result or product is indicated by block 308 in FIG. 3A. In response, website component 132 illustratively generates a display, such as display 310 shown in FIG. 4C. It can be seen that display 310 includes a detailed product display portion 312 that displays more detailed product information for the selected product. It also illustratively includes a social network identifier portion 314 that identifies others in the social graph of user 110 that have purchased the product or written a review about the product, etc. If user 110 actuates identifier 314 it illustratively navigates the user 110 to the social network site of the identified person, to the review written by the person, or it initiates a communication with that person. Display 310 also illustratively includes a purchase user input mechanism 316 that allows user 110 to purchase the product from retailer 102.

Receiving a transaction input to purchase the given product or service is indicated by block 310 in FIG. 3A. Once the user 110 has purchased the product, website component 132 illustratively generates a user interface display that allows the user 110 to share the transaction information with social retail system 126. This is indicated by block 312. FIG, 4D shows one embodiment of an illustrative user interface display 314 that indicates this. It can be seen that user interface display 314 includes a variety of information reflecting the commercial transaction. It identifies the product that was purchased in section 316, and it identifies a particular method of payment in section 318. It also illustratively provides a user input mechanism 320 that allows the user to share the information with others using social retail system 126. In one embodiment, the user is offered an extra discount if the user 110 shares the transaction information.

When the transaction is complete, transaction component 130 of retailer 102 logs the transaction data in data store 136. This is indicated by block 322 in FIG. 3B. In one embodiment, transaction component 130 also logs information indicating whether the transaction data is to be shared with social retail system 126. Therefore, when social retail system 126 next receives transaction data from retailer 102, this particular transaction data will be included, if the user has authorized it to be shared.

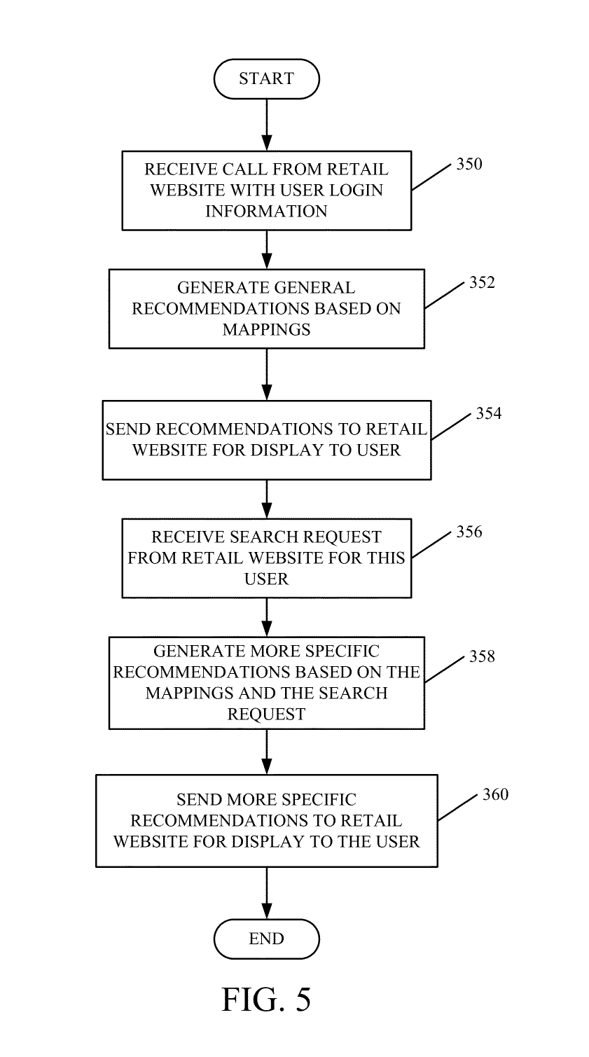

FIG. 5 is a flow diagram showing one embodiment of the operation of social retail system 126 in generating recommendations to be displayed at a retailer website 106. Social retail system 126 first receives a call from the retail website with user login information. This is indicated by block 350 in FIG. 5. Recommendation engine 148 then accesses mappings 153 in data store 152 and generates (or retrieves) general recommendations based on those mappings, and simply based on the fact that this given user has logged into the website of this given retailer. This is indicated by block 352. Recommendation engine 148 then sends the recommendations to the retailer website 106 where they are displayed to the user. This is indicated by block 354.

When the website receives a product search request from the user, it sends it to social retail website 126. Receiving the search information (or search request) from the retail website 106 for this given user 110 is indicated by block 356. Recommendation engine 148 then generates (or retrieves) more specific recommendations based upon the mappings 153 and the search terms input by user 110. This is indicated by block 358. In one embodiment, recommendation engine 148 performs this calculation by identifying items that have been purchased from this retailer by others in the user's social graph, and by assigning each of them a score based on how close the product is to the one the user 110 is searching for, and based upon how influential the buyer is for this given user 110. One embodiment of an equation to assign a score is indicated by Equation 1 below:

$${\sum }_{d = 1}^{2} \frac{\begin{matrix}\sum f ∈ FollowedBy ( {U}_{i , d} ) ( Influence ( f , {U}_{i} , {I}_{k} ) \times \\ {\sum }_{p ∈ Items ( f )} \frac{Rating ( f , p ) \times Similarity ( p , {I}_{k} )}{CountItems ( f )} )\end{matrix}}{d \times CountBuyers ( {I}_{k} , {U}_{i} , d )}$$

The term Uᵢ indicates the present user 110 and the term Iₖ indicates a specific item that is being sought by user 110. The score is thus assigned to indicate whether a particular item is to be recommended to this particular user 110. The term f represents a friend of the user (or another user that user 110 follows or who is in the social graph of the present user 110) and the term d represents a distance from the present user that the friend is in the social graph. For instance, if a close friend (one directly linked to the user in the user's social graph) purchased the product, that will be given more weight than if it is a user that is only indirectly linked to the present user 110 (e.g., a friend of a friend). The term Influence(f, Uᵢ,Iₖ) represents the influence of a given friend f on this particular user Uᵢ, for this particular product Iₖ. The second summation in the numerator of Equation 1 deals with related products. For example, the rating term is a rating indicating how much a friend f liked the product p. The similarity term indicates how similar the product p is to the current product Iₖ being researched by the present user 110. The term CountItems(f) is the number of items that this particular friend has purchased. If a certain friend purchases a large number of items, then the effect of their purchase is less than if they only purchase a few items. The denominator (i.e., the CountBuyers(Iₖ, Uᵢ, d) term) effectively averages the score, because the numerator in Equation 1 is being divided by the total number of buyers. In one embodiment, recommendation engine 148 periodically pre-calculates all of these calculations for all of the users and products in data store 152. Therefore, they need not necessarily be calculated in real time, but can instead be calculated off line.

In any case, once the recommendations are calculated by recommendation engine 148, they are sent to retailer website 106 where they can be displayed to the user 110. This is indicated by block 360 in FIG. 5.

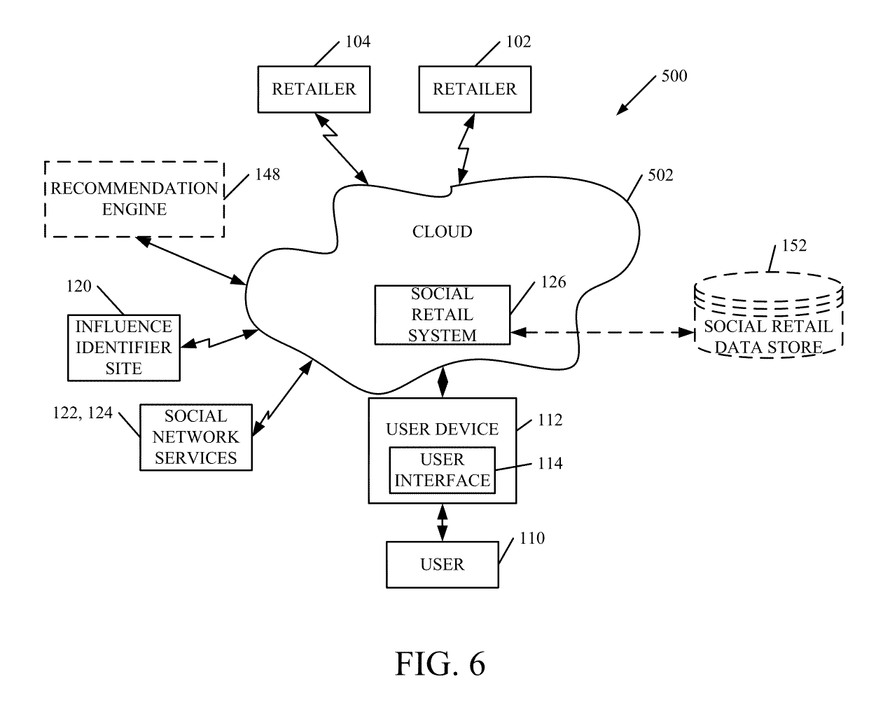

FIG. 6 is a block diagram of architecture 100, shown in FIG. 1, except that it's elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the embodiment shown in FIG. 6, some items are similar to those shown in FIG. 1 and they are similarly numbered. FIG. 6 specifically shows that social retail system 126 is located in cloud 502 (which can be public, private, or a combination where portions are public while others are private). Therefore, user 110 uses a user device 112 to access those systems through cloud 502. FIG. 6 also depicts another embodiment of a cloud architecture. FIG. 6 shows that it is also contemplated that some elements of social retail system 126 are disposed in cloud 502 while others are not. By way of example, data store 152 can be disposed outside of cloud 502, and accessed through cloud 502. In another embodiment, recommendation engine 148 and is also outside of cloud 502. Regardless of where they are located, they can be accessed directly by device 112, through a network (either a wide area network or a local area network), they can be hosted at a remote site by a service, or they can be provided as a service through a cloud or accessed by a connection service that resides in the cloud. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

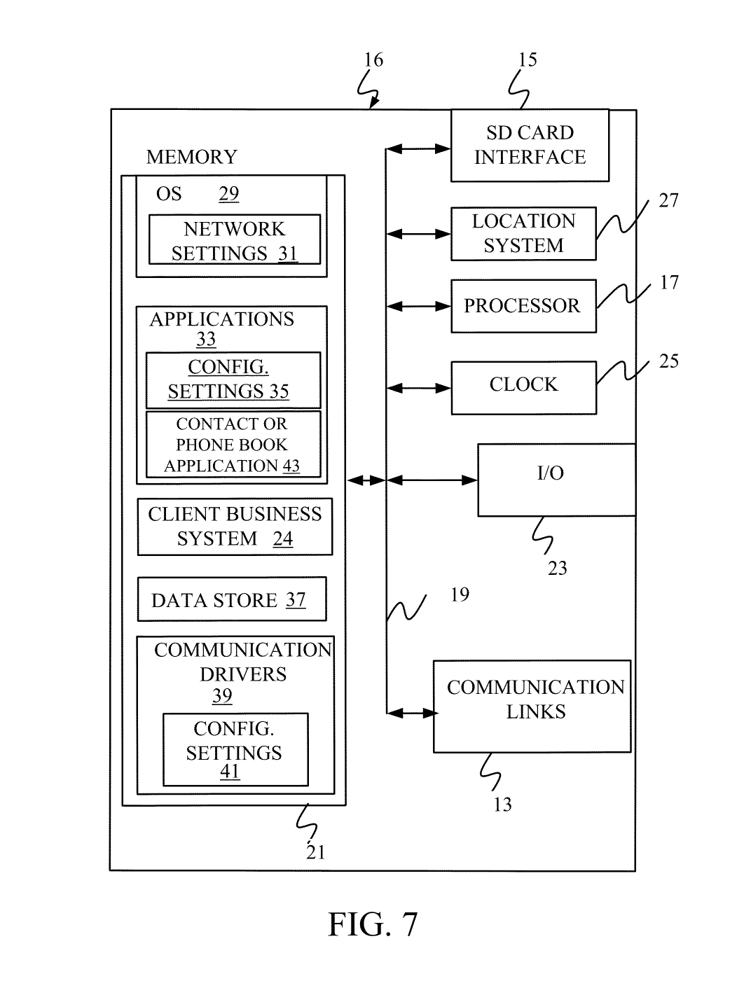

FIG. 7 is a simplified block diagram of one illustrative embodiment of a handheld or mobile computing device that can be used as a user's or client's hand held device 16, in which the present system (or parts of it) can be deployed. FIGS. 7-12 are examples of handheld or mobile devices.

FIG. 7 provides a general block diagram of the components of a client device 16 that can run components of architecture 100 or system 126 or that interacts with architecture 100, or both. In the device 16, a communications link 13 is provided that allows the handheld device to communicate with other computing devices and under some embodiments provides a channel for receiving information automatically, such as by scanning Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1Xrtt, and Short Message Service, which are wireless services used to provide cellular access to a network, as well as 802.11 and 802.11b (Wi-Fi) protocols, and Bluetooth protocol, which provide local wireless connections to networks.

Under other embodiments, applications or systems (like mobile retailer app 138) are received on a removable Secure Digital (SD) card that is connected to a SD card interface 15. SD card interface 15 and communication links 13 communicate with a processor 17 (which can also embody the processors from FIG. 1) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Similarly, device 16 can have a client business system 24 which can run various business applications or embody parts or all of architecture 100. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

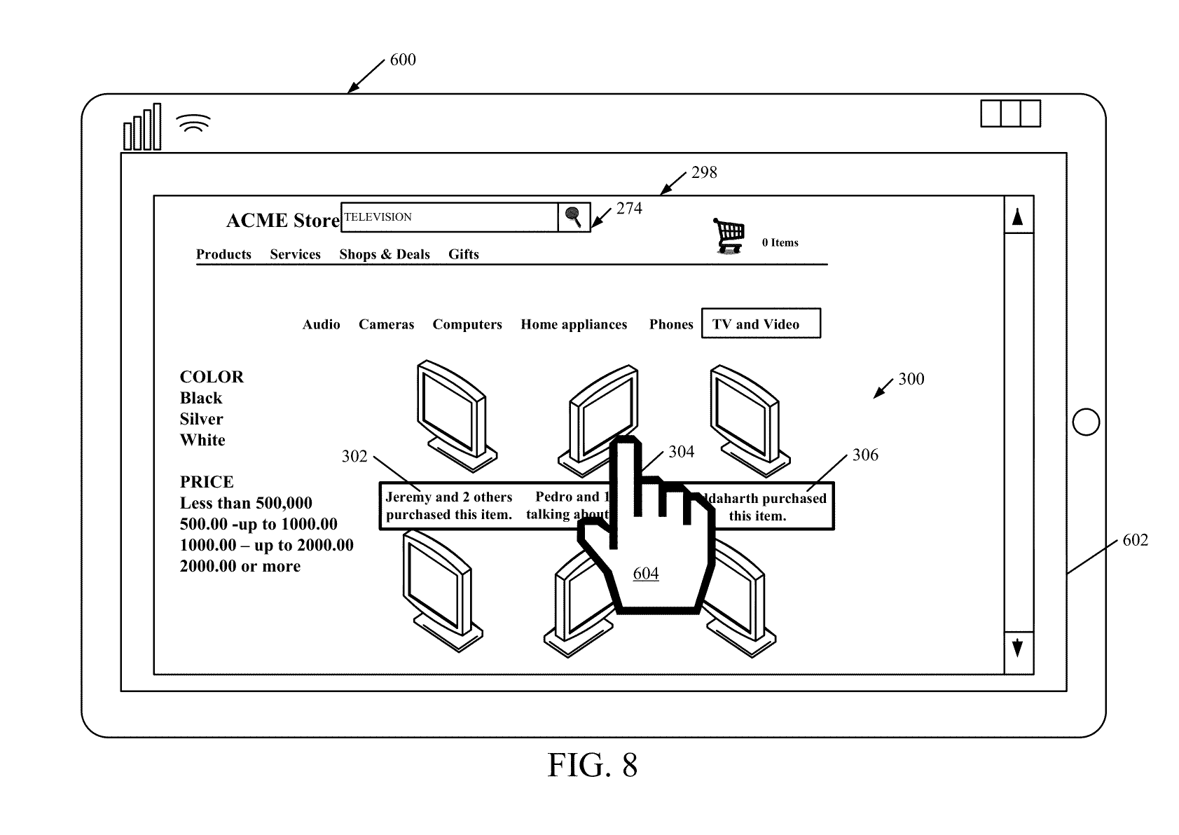

FIG. 8 shows one embodiment in which device 16 is a tablet computer 600. In FIG. 8, computer 600 is shown with user interface display 298 (From FIG. 4B) displayed on the display screen 602. Screen 602 can be a touch screen (so touch gestures from a user's finger 604 can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

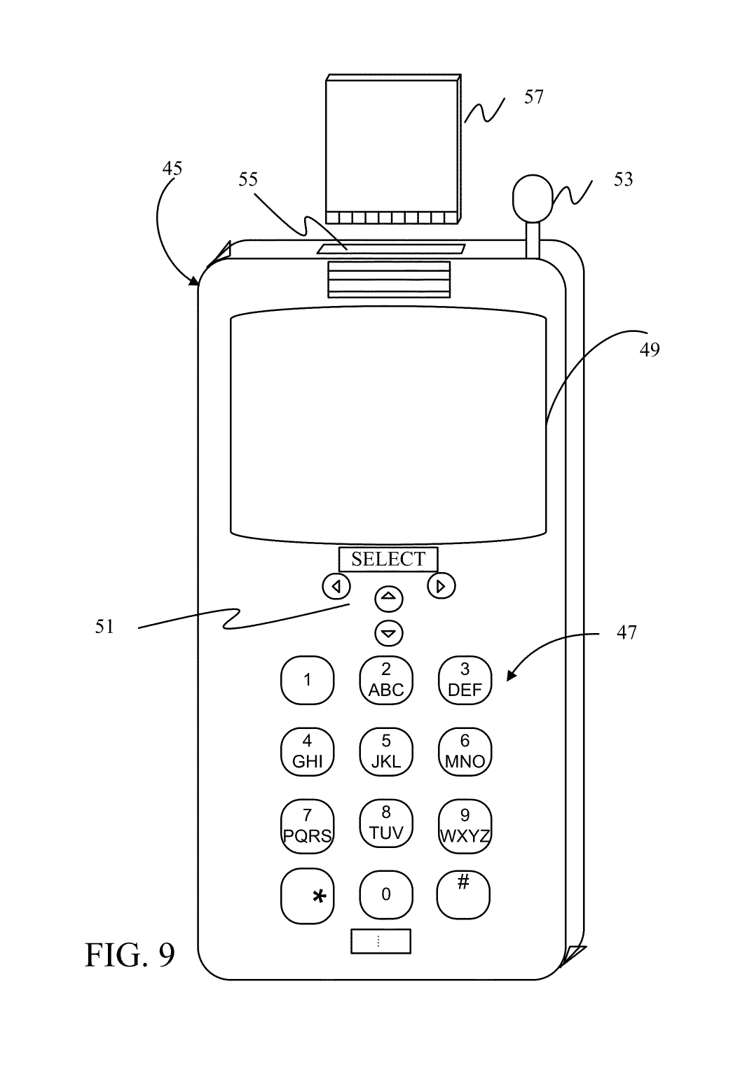

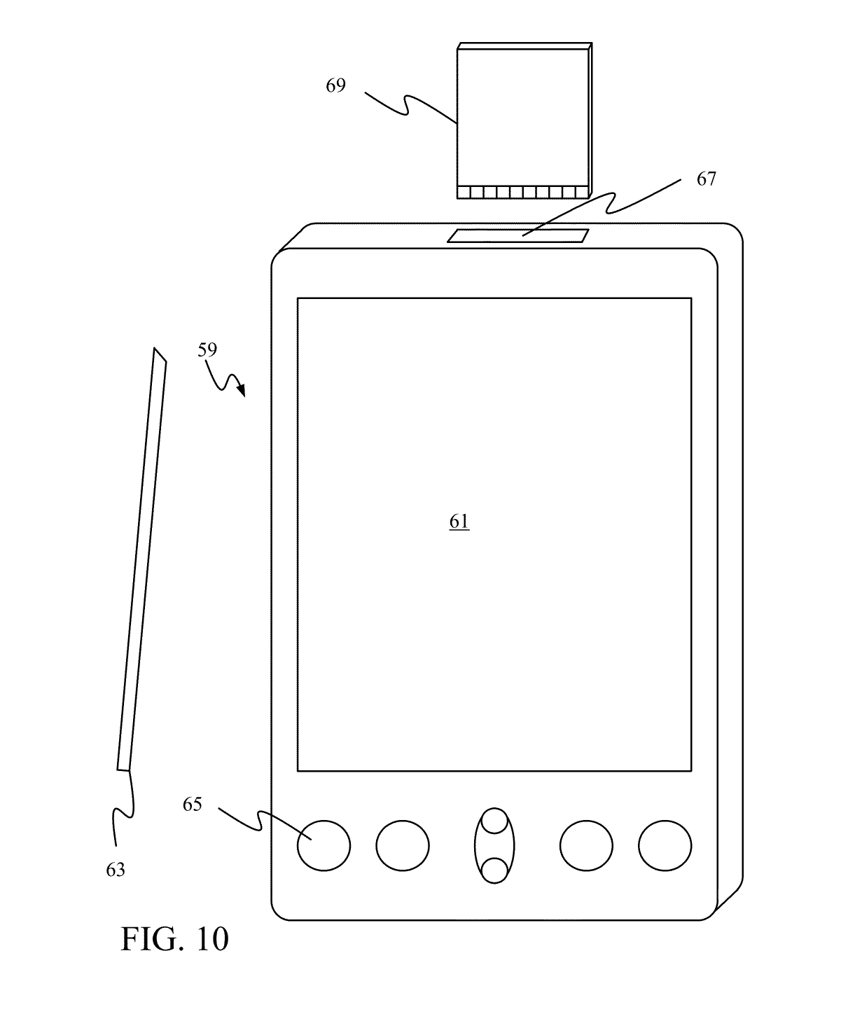

FIGS. 9 and 10 provide additional examples of devices 16 that can be used, although others can be used as well. In FIG. 9, a feature phone, smart phone or mobile phone 45 is provided as the device 16. Phone 45 includes a set of keypads 47 for dialing phone numbers, a display 49 capable of displaying images including application images, icons, web pages, photographs, and video, and control buttons 51 for selecting items shown on the display. The phone includes an antenna 53 for receiving cellular phone signals such as General Packet Radio Service (GPRS) and 1Xrtt, and Short Message Service (SMS) signals. In some embodiments, phone 45 also includes a Secure Digital (SD) card slot 55 that accepts a SD card 57.

The mobile device of FIG. 10 is a personal digital assistant (PDA) 59 or a multimedia player or a tablet computing device, etc. (hereinafter referred to as PDA 59). PDA 59 includes an inductive screen 61 that senses the position of a stylus 63 (or other pointers, such as a user's finger) when the stylus is positioned over the screen. This allows the user to select, highlight, and move items on the screen as well as draw and write. PDA 59 also includes a number of user input keys or buttons (such as button 65) which allow the user to scroll through menu options or other display options which are displayed on display 61, and allow the user to change applications or select user input functions, without contacting display 61. Although not shown, PDA 59 can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections. In one embodiment, mobile device 59 also includes a SD card slot 67 that accepts a SD card 69.

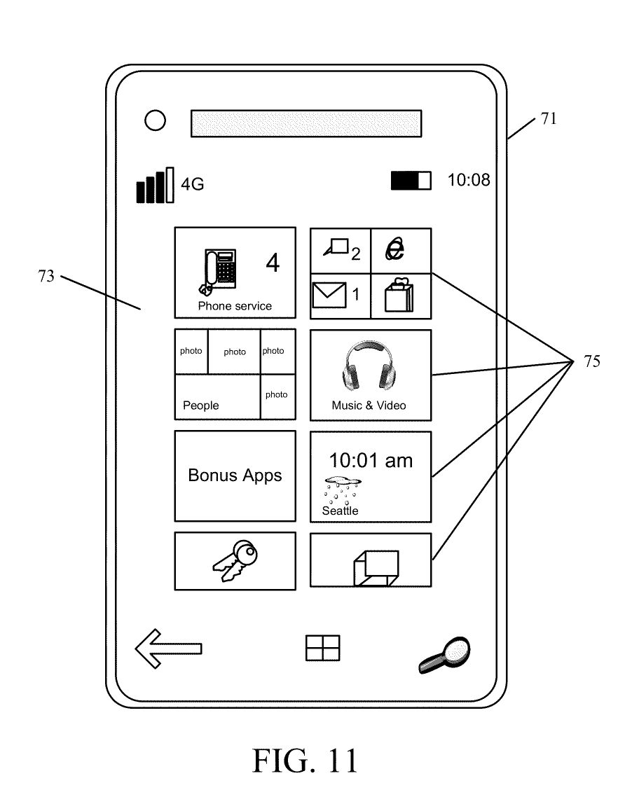

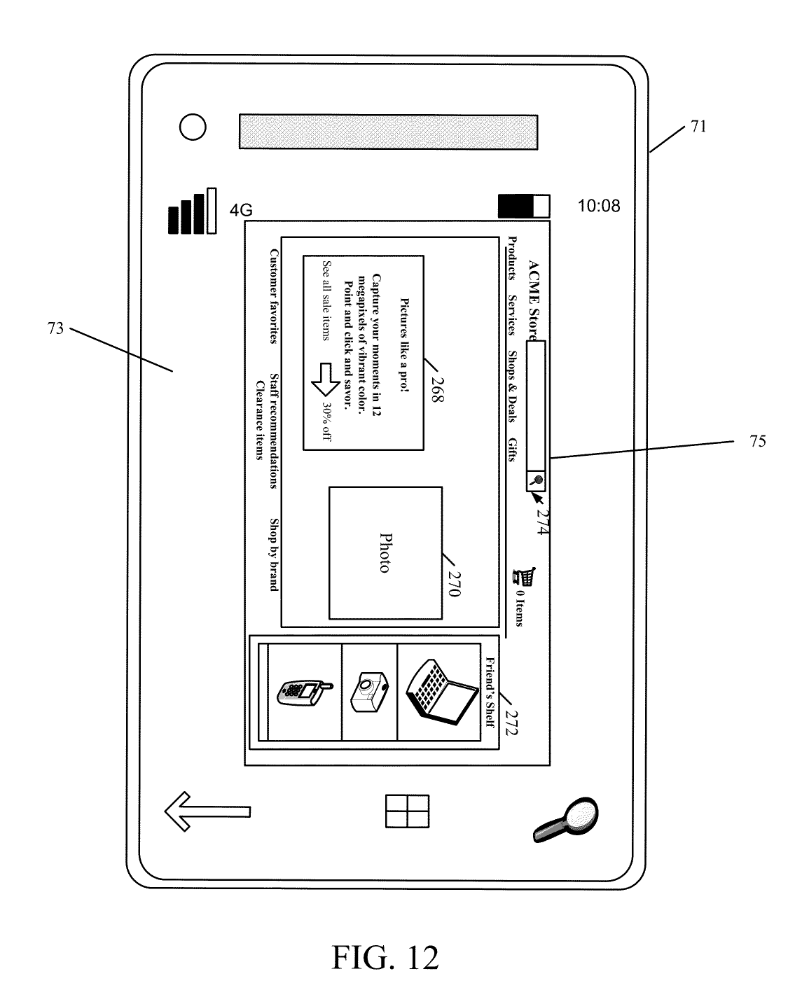

FIG. 11 is similar to FIG. 9 except that the phone is a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone. FIG. 12 shows phone 71 with display 266 of FIG. 4A displayed thereon.

Note that other forms of the devices 16 are possible.

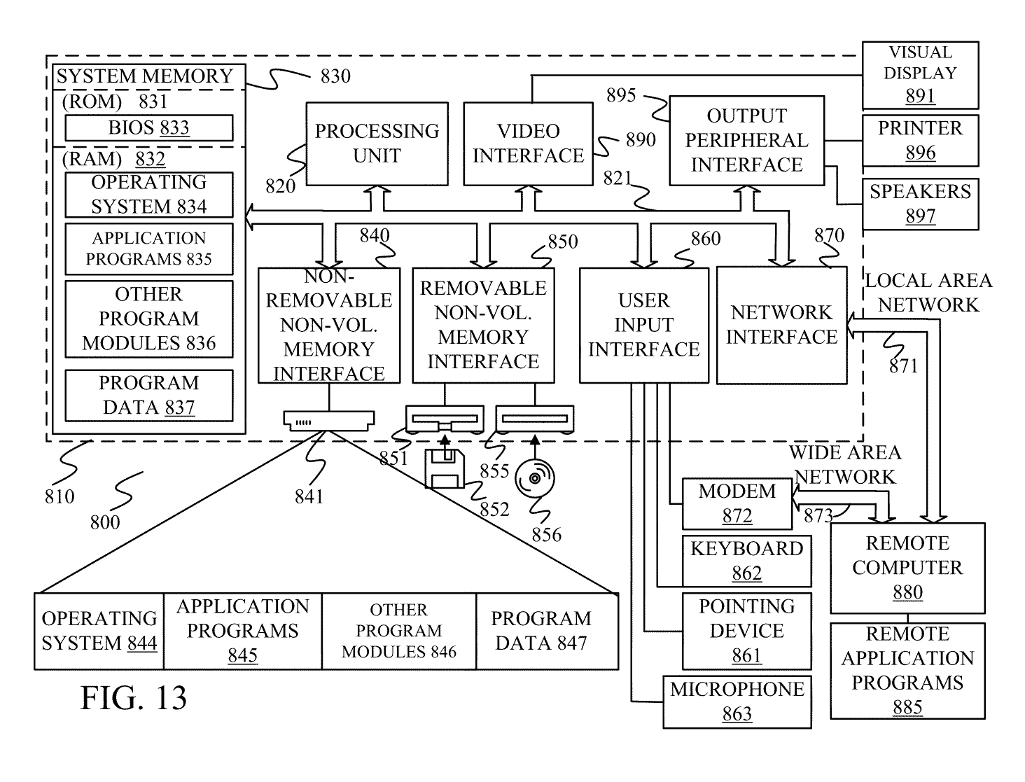

FIG. 13 is one embodiment of a computing environment in which architecture 100, or parts of it, (for example) can be deployed. With reference to FIG. 13, an exemplary system for implementing some embodiments includes a general-purpose computing device in the form of a computer 810. Components of computer 810 may include, but are not limited to, a processing unit 820 (which can comprise one or more processors from FIG. 1), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 13.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 13 illustrates operating system 834, application programs 835, other program modules 836, and program data 837.

The computer 810 may also include other removable/non-removable volatile/nonvolatile computer storage media. By way of example only, FIG. 13 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 13, provide storage of computer readable instructions, data structures, program modules and other data for the computer 810. In FIG. 13, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 13 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 13 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method of processing transaction data, comprising:
receiving user login information indicative of a given user logging into a commercial transaction system;
receiving recommendation information indicative of commercial transactions performed at the commercial transaction system by a member of a social graph of the given user; and
displaying the recommendation information including transaction information indicative of a given commercial transaction and social network information identifying a given member of the social graph of the given user that performed the given commercial transaction.

2. The computer-implemented method of claim 1 wherein the commercial transaction system comprises a seller that provides a seller website, and wherein the given commercial transaction comprises purchasing an item of goods or services from the seller.

3. The computer-implemented method of claim 2 wherein displaying the recommendation information comprises:
displaying a first actuatable user input mechanism; and
in response to actuation of the first actuatable user input mechanism, displaying items purchased from the seller by others in the social graph of the given user.

4. The computer-implemented method of claim 3 wherein displaying the recommendation information comprises:
displaying a second actuatable user input mechanism; and
in response to actuation of the second actuatable user input mechanism, displaying a discussion among people in the social graph of the given user about items offered by the seller.

5. The computer-implemented method of claim 4 wherein displaying the recommendation information comprises:
displaying a third actuatable user input mechanism; and
in response to actuation of the third actuatable user input mechanism, displaying a live stream indicative of items purchased from the seller by others, including those outside the social graph of the given user.

6. The computer-implemented method of claim 2 and further comprising:
receiving a search request from the given user indicative of a search for a given item on the seller website;
receiving recommendation information indicative of a purchase of the given item, or a similar item, from the seller by a member of the social graph of the given user; and
displaying the recommendation information including the transaction information indicative of the purchase of the given item or similar item and the social network information identifying the member of the social graph of the given user that purchased the given item or similar item.

7. The computer-implemented method of claim 6 wherein displaying the social network information identifying the member of the social graph of the given user that purchased the given item or similar item comprises:
displaying a link to a social network site of the member of the social graph of the given user that purchased the given item or similar item.

8. The computer-implemented method of claim 6 wherein displaying the social network information identifying the member of the social graph of the given user that purchased the given item or similar item comprises:
displaying a link to a discussion site hosting a discussion among people including the member of the social graph of the given user that purchased the given item or similar item.

9. The computer-implemented method of claim 6 wherein displaying the social network information identifying the member of the social graph of the given user that purchased the given item or similar item comprises:
displaying a link to a review of the given item or similar item by the member of the social graph of the given user that purchased the given item or similar item.

10. The computer-implemented method of claim 6 wherein displaying the social network information identifying the member of the social graph of the given user that purchased the given item or similar item comprises:
displaying a communication link to initiate communication with the member of the social graph of the given user that purchased the given item or similar item.

11. The computer-implemented method of claim 6 wherein displaying the recommendation information comprises:
displaying the recommendation information including the transaction information indicative of the purchase of a related item, related to the given item or similar item, and the social network information identifying the member of the social graph of the given user that purchased the related item.

12. A commercial transaction system, comprising:
a recommendation engine that receives user information indicative of a given user and seller information indicative of a given seller and that accesses mapping information that maps members of a social graph for the given user to transaction data indicative of commercial transactions performed at the given seller, the recommendation engine generating a recommendation of an item of goods or services, offered by the given seller, for the given user, based on mapping information; and
a computer processor that is a functional part of the system and activated by the recommendation engine to facilitate receiving the user information and the seller information, accessing the mapping information and generating the recommendation.

13. The commercial transaction system of claim 12 and further comprising:
a crawler component that receives a social network identifier identifying a social network account for the given user and obtains social network information for the given user, the social network information including a social graph corresponding to the given user.

14. The commercial transaction system of claim 13 wherein the crawler obtains influence data indicative of members of the social graph corresponding to the given user that have purchasing influence over the given user.

15. The commercial transaction system of claim 12 wherein the recommendation engine intermittently calculates recommendations off line.

16. A computer readable storage medium that stores computer readable instructions which, when executed by a computer, cause the computer to perform steps, comprising:
receiving a user social network identifier indicative of a social network account of a given user;
receiving a commercial transaction system identifier indicative of a commercial transaction system being accessed by the given user
receiving recommendation information indicative of commercial transactions performed at the commercial transaction system by a member of a social graph corresponding to the given user; and
displaying the recommendation information including transaction information indicative of a given commercial transaction and social network information identifying a given member of the social graph corresponding to the given user that performed the given commercial transaction.

17. The computer readable storage medium of claim 16 wherein the commercial transaction system comprises a seller that provides a seller website, and wherein the given commercial transaction comprises purchasing an item of goods or services from the seller, and further comprising:
receiving a search request from the given user indicative of a search for a given item on the seller website;
receiving recommendation information indicative of a purchase of the given item, or a similar item, from the seller by a member of the social graph corresponding to the given user; and
displaying the recommendation information including the transaction information indicative of the purchase of the given item or similar item and the social network information identifying the member of the social graph corresponding to the given user that purchased the given item or similar item.

18. The computer readable storage medium of claim 17 wherein displaying the recommendation information comprises:
displaying discussion information indicative of a discussion among members of the social graph corresponding to the given user about the given item or similar item.

19. The computer readable storage medium of claim 17 wherein displaying the recommendation information comprises:
displaying a user actuatable link which, when actuated, navigates the given user to a social network site for the member of the social graph of the given user that purchased the given item or similar item.

20. The computer readable storage medium of claim 17 wherein displaying the recommendation information comprises:
displaying a user actuatable communication link which, when actuated, initiates communication with the member of the social graph of the given user that purchased the given item or similar item.
